(19) United States
(12) Patent Application Publication
(10) Pub. No.: US 2018/0279777 A1
(43) Pub. Date: Oct. 4, 2018

(54) Simple Ceramic Combined Cabinet

(71) Applicant: GUANGDONG TOPLUX CHINA CABINET CO., LTD., Dongguan (CN)

(72) Inventor: Hanbin Huang, Dongguan (CN)

(21) Appl. No.: 15/995,127

(22) Filed: Jun. 1, 2018

Related U.S. Application Data
(63) Continuation of application No. PCT/CN2016/111525, filed on Dec. 22, 2016.

(51) Int. Cl. A47B 77/02; F16B 12/14

(52) U.S. Cl. CPC A47B 77/02; A47B 96/00; F16B 12/14

(57) ABSTRACT

A simple ceramic combined cabinet comprises a bottom plate with left and right mounting holes formed in the edges of two sides, a left side plate, a right side plate, a back plate, which are all ceramic plates; and a first, a second and a third connecting blocks, wherein first mounting holes are formed in the bottom surfaces of the left and right side plates respectively, second mounting holes are formed in the upper portions of the left and right side plates; third mounting holes paired with the second mounting holes are formed in end faces of the first, second and third connecting blocks; mounting hole sites are symmetrically located on the left and right side plates in a penetrating mode respectively, and connecting pieces used for mounting door hinges or guide rails are arranged on the hole sites in a penetrating mode.

### CROSS-REFERENCE TO RELATED APPLICATIONS

This application is a Continuation Application of PCT Application No. PCT/CN2016/111525, filed on Dec. 22, 2016, the entire contents of which are hereby incorporated by reference.

### TECHNICAL FIELD

The invention relates to the technical field of furniture, in particular to a healthy and environment-friendly simple ceramic combined cabinet that can be combined with metal blocks and can be mounted and dismounted repeatedly.

### BACKGROUND

Floor cabinets that are made of wood veneer plates and stainless steel plates on the market are generally applied to kitchens, bathrooms, indoors and outdoors at present. The cabinets made of wood veneer plates are poor in water-proof performance, mold-proof performance and corrosion resistance and also poor in environmental friendliness; the floor cabinets made of stainless steel plates can generate high noise when storing articles such as tableware and sanitary ware and are prone to deformation and poor in electric conductivity and corrosion resistance; floor cabinets made of marble plates are mostly connected with chemical glue and are poor in bearing capacity, can generate radiation and are prone to breakage; only one side of the marble plates is polished, and dirt is prone to being accumulated in holes in the other sides of the marble plates, and consequentially the marble plates are difficult to clean. Floor cabinets that are made of artificial stones, quartz stones and other materials are all synthesized through chemical raw materials, thereby being poor in environmental friendliness and having great influences on human bodies.

### SUMMARY OF THE INVENTION

To overcome the above defects, the invention provides a simple ceramic combined cabinet which is good in water-proof performance, fire-proof performance and mold-proof performance, good in corrosion resistance, nonconductive, rich in color, good in bearing capacity and easy to mount and dismount, is assembled through screw joint on the whole, and is easy to clean, environmentally friendly and healthy.

The aim of the invention is realized in the following way:

According to the invention, ceramic plates and metal blocks are mainly combined to form a cabinet body, and the cabinet body can be mounted and dismounted repeatedly, thereby being healthier and more environmentally friendly.

Provided is a simple ceramic combined cabinet, and the combined cabinet is provided with a cabinet body with one or more independent storage spaces and comprises a bottom plate, a left side plate, a right side plate, a back plate, a first connecting block, a second connecting block and a third connecting block, wherein the bottom plate, the left side plate, the right side plate and the back plate are all ceramic plates, left mounting holes and right mounting holes are formed in the edges of the two sides of the bottom plate respectively, and first mounting holes are formed in the bottom surface of the left side plate and the bottom surface of the right side plate respectively, so that the bottom plate, the left side plate and the right side plate are fixed together through screw joint; second mounting holes are symmetrically formed in the upper portion of the left side plate and the upper portion of the right side plate, and third mounting holes which are paired with the second mounting holes are formed in the two ends faces of the first connecting block, the two end faces of the second connecting block and the two end faces of the third connecting block respectively; the left side plate and the right side plate are fixedly connected together through screw joint by the first connecting block, the second connecting block and the third connecting block; a first clamping groove and a second clamping groove are formed in the side edge of the second connecting block and the side edge of the third connecting block respectively, and the two ends of the back plate are detachably clamped in the first clamping groove and the second clamping groove; mounting hole sites are symmetrically located on the left side plate and the right side plate in a penetrating mode respectively, and connecting pieces used for mounting door hinges or guide rails are arranged on the mounting hole sites in a penetrating mode.

Preferably, each connecting piece is composed of a connector and a connecting rod, wherein a first inner toothed hole is formed in one end face of the connecting rod, a second inner toothed hole is formed in the other end face of the connecting rod, and the first inner toothed hole is connected and communicated with the second inner toothed hole; the connector comprises a limiting base, and a connecting post which is in screw joint with the first inner toothed hole is arranged in the middle of the limiting base and extends upwards.

Preferably, one end of each connecting rod is provided with one or more upward protrusions and an anti-rotation convex ring integrally formed together with the connecting rod, the anti-rotation convex rings surround the outer walls of the connecting rods, and each anti-rotation convex ring is of a polygonal structure.

Preferably, an external thread which is in screw joint with the corresponding first inner toothed hole in a paired mode is arranged on the connecting post of each connector.

Preferably, fixing bases used for mounting supporting legs are arranged at the four corners of the bottom surface of the bottom plate respectively, and slots connected with the supporting legs are formed in the fixing bases.

Preferably, the fixing bases are fixed to the bottom plate through glue or through screw joint.

Compared with the prior art, the simple ceramic combined cabinet of the invention has the beneficial effects that the simple ceramic combined cabinet is assembled by the ceramic plates and the metal plates through screw joint and is firm in structure, thereby being good in water-proof performance, fire-proof performance and mold-proof performance, high in corrosion resistance, good in abrasion resistance, nonconductive and capable of being made of plates in rich colors; since the inner surfaces and the outer surfaces of the ceramic plates are smooth surfaces, the ceramic plates are easy to clean and maintain and free of formaldehyde and accordingly have the characteristics of being environmentally friendly and healthy.

### BRIEF DESCRIPTION OF THE DRAWINGS

FIG. 1 is a solid structural diagram of an embodiment of the invention;

FIG. 2 is a bottom structural diagram of the embodiment of the invention;

FIG. 3 is a structural diagram of a connecting piece in the embodiment of the invention.

In the FIGs, 1—bottom plate, 2—left side plate, 3—right side plate, 4—back plate, 5—first connecting block, 6—second connecting block, 7—third connecting block, 8—mounting hole site, 9—connecting piece, 901—connector, 902—connecting rod, 903—anti-rotation convex ring, 10—fixing base.

### DETAILED DESCRIPTION OF THE EMBODIMENTS

A further detailed description of the invention is given with the accompanying drawings and specific embodiments as follows.

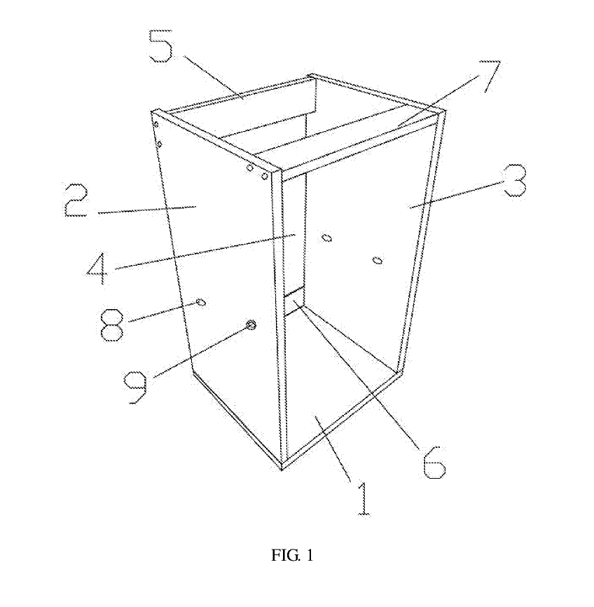

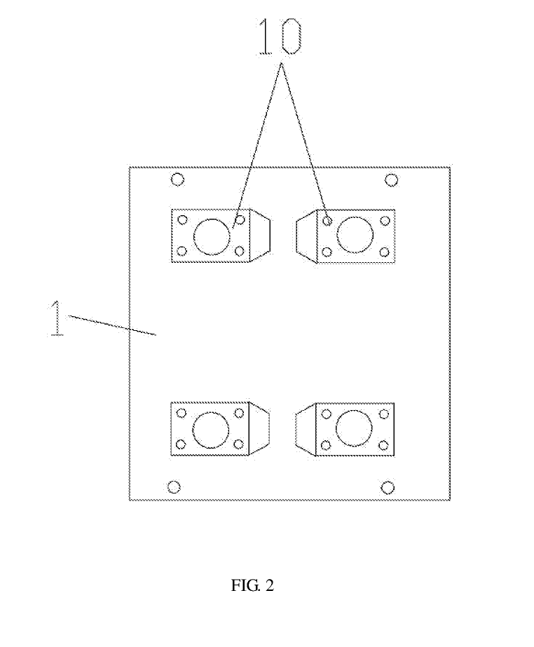

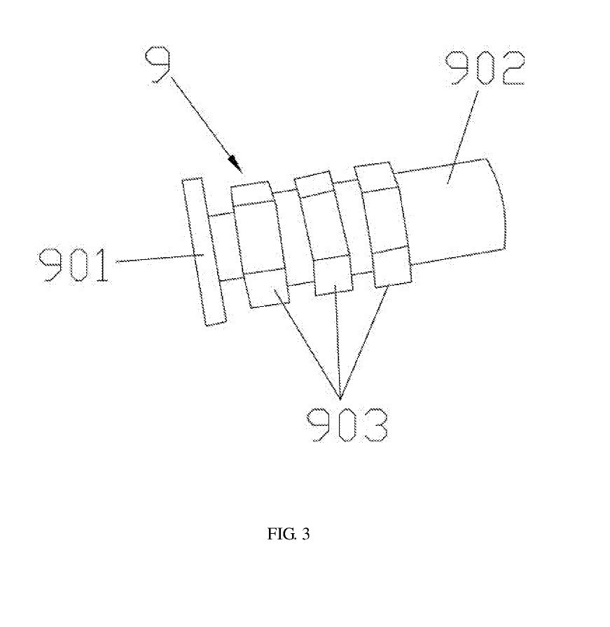

In the embodiment, as is shown in FIGS. 1-3, a simple ceramic combined cabinet in the scheme is provided with a cabinet body with one or more independent storage spaces and comprises a bottom plate 1, a left side plate 2, a right side plate 3, a back plate 4, a first connecting block 5, a second connecting block 6 and a third connecting block 7, and the first connecting block 5, the second connecting block 6 and the third connecting block 7 are all made of aluminum alloy.

The simple ceramic combined cabinet is different from the prior art in that the simple ceramic combined cabinet is assembled integrally and is easier and more convenient to mount and dismount; the bottom plate 1, the left side plate 2, the right side plate 3 and the back plate 4 are all ceramic plates, left mounting holes and right mounting holes are formed in the edges of the two sides of the bottom plate 1 respectively, first mounting holes are formed in the bottom surface of the left side plate 2 and the bottom surface of the right side plate 3 respectively, and thus the bottom plate 1, the left side plate 2 and the right side plate 3 are fixed together through screw joint; second mounting holes are symmetrically formed in the upper portion of the left side plate 2 and the upper portion of the right side plate 3, third mounting holes which are paired with the second mounting holes are formed in the two end faces of the first connecting block 5, the two end faces of the second connecting block 6 and the two end faces of the third connecting block 7 respectively, and the left side plate 2 and the right side plate 3 are fixedly connected together through screw joint by the first connecting block 5, the second connecting block 6 and the third connecting block 7; a first clamping groove and a second clamping groove are formed in the side edge of the second connecting block 6 and the side edge of the third connecting block 7 respectively, and the two ends of the back plate 4 are detachably clamped in the first clamping groove and the second clamping groove; mounting hole sites 8 are symmetrically located on the left side plate 2 and the right side plate 3 in a penetrating mode respectively, and connecting pieces 9 used for mounting door hinges or guide rails are arranged on the mounting hole sites 8 in a penetrating mode.

Wherein, each connecting piece in the embodiment is composed of a connector 901 and a connecting rod 902, wherein a first inner toothed hole is formed in one end face of the connecting rod 902, a second inner toothed hole is formed in the other end face of the connecting rod 902, and the first inner toothed hole is connected and communicated with the second inner toothed hole; the connector 901 comprises a limiting base, and a connecting post which is in screw joint with the first inner toothed hole is arranged in the middle of the limiting base and extends upwards. One end of each connecting rod 902 is provided with one or more upward protrusions and an anti-rotation convex ring 903 which is integrally formed together with the connecting rod 902, the anti-rotation convex rings 903 surround the outer walls of the connecting rods 902, and each anti-rotation convex ring 903 is of a polygonal structure. An external thread which is in screw joint with the corresponding first inner toothed hole in a paired mode is arranged on the connecting post of each connector 901.

In addition, fixing bases 10 used for mounting supporting legs are arranged at the four corners of the bottom surface of the bottom plate 1 respectively, and slots connected with the supporting legs are formed in the fixing bases 10. The fixing bases 10 are fixed to the bottom plate 1 through glue or through screw joint. Compared with the prior art, the simple ceramic combined cabinet is formed by assembling the ceramic plates and the metal plates through screw joint and is firm in structure, thereby being good in water-proof performance, fire-proof performance and mold-proof performance, good in corrosion resistance, good in abrasion resistance, nonconductive, and capable of being made of plates in rich colors, and since the inner surfaces and the outer surfaces of the ceramic plates are smooth surfaces, the ceramic plates are easy to clean and maintain and free of formaldehyde and accordingly have the characteristics of being environmentally friendly and healthy.

The above content represents a further detailed description of the invention made with specific preferred embodiments, however, the invention is not only limited to the above description when implemented specifically. For those skilled in the field, several simple deductions or substitutes can also be made without deviating from the concept of the utility mode, and all the deductions or substitutes are within the protection scope of the invention.

What is claimed is:

1. A simple ceramic combined cabinet, provided with a cabinet body with one or more independent storage spaces and comprising a bottom plate, a left side plate, a right side plate, a back plate, a first connecting block, a second connecting block and a third connecting block; wherein the bottom plate, the left side plate, the right side plate and the back plate are all ceramic plates, left mounting holes and right mounting holes are formed in the edges of the two sides of the bottom plate respectively, and first mounting holes are formed in the bottom surface of the left side plate and the bottom surface of the right side plate respectively, so that the bottom plate, the left side plate and the right side plate are fixed together through screw joint; second mounting holes are symmetrically formed in the upper portion of the left side plate and the upper portion of the right side plate, and third mounting holes which are paired with the second mounting holes are formed in the two ends faces of the first connecting block, the two end faces of the second connecting block and the two end faces of the third connecting block respectively; the left side plate and the right side plate are fixedly connected together through screw joint by the first connecting block, the second connecting block and the third connecting block; a first clamping groove and a second clamping groove are formed in the side edge of the second connecting block and the side edge of the third connecting block respectively, and the two ends of the back plate are detachably clamped in the first clamping groove and the second clamping groove; mounting hole sites are symmetrically located on the left side plate and the right side plate in a penetrating mode respectively, and connecting pieces used for mounting door hinges or guide rails are arranged on the mounting hole sites in a penetrating mode.

2. The simple ceramic combined cabinet according to claim 1, wherein each connecting piece is composed of a connector and a connecting rod, wherein a first inner toothed hole is formed in one end face of the connecting rod, a second inner toothed hole is formed in the other end face of the connecting rod, and the first inner toothed hole is connected and communicated with the second inner toothed hole; the connector comprises a limiting base, and a connecting post which is in screw joint with the first inner toothed hole is arranged in the middle of the limiting base and extends upwards.

3. The simple ceramic cabinet according to claim 2, wherein one end of each connecting rod is provided with one or more upward protrusions and an anti-rotation convex ring integrally formed together with the connecting rod, the anti-rotation convex rings surround the outer walls of the connecting rods, and each anti-rotation convex ring is of a polygonal structure.

4. The simple ceramic combined cabinet according to claim 2, wherein an external thread which is in screw joint with the corresponding first inner toothed hole in a paired mode is arranged on the connecting post of each connector.

5. The simple ceramic combined cabinet according to claim 4, wherein fixing bases used for mounting supporting legs are arranged at the four corners of the bottom surface of the bottom plate respectively, and slots connected with the supporting legs are formed in the fixing bases.

6. The simple ceramic combined cabinet according to claim 5, wherein the fixing bases are fixed to the bottom plate through glue or through screw joint.
